(19) United States
(12) Patent Application Publication
(10) Pub. No.: US 2017/0299512 A1
(43) Pub. Date: Oct. 19, 2017

(54) Differential Excitation Raman Spectroscopy

(71) Applicants: Boyd V. Hunter, Albuquerque, NM (US); Michael A. Miller, San Antonio, TX (US)

(72) Inventors: Boyd V. Hunter, Albuquerque, NM (US); Michael A. Miller, San Antonio, TX (US)

(21) Appl. No.: 15/099,088

(22) Filed: Apr. 14, 2016

(51) Int. Cl. G01N 21/63; G01N 21/65

(52) U.S. Cl. CPC G01N 21/636; G01N 21/65; G01N 2201/0683; G01N 2201/06113

(57) ABSTRACT

Raman instrumentation for detecting for the presence of a molecular species in a including: a source of radiation for pumping the sample; apparatus for controlling the frequency and pulse width of radiation from the pumping source; a Raman spectrometer including a detector and means for collecting scattered photons from the sample; a radiation source for probing the sample; means for directing radiation from the probing source to the sample; and means to interface the spectrometer with the source of radiation for pumping. The radiation source for probing is, preferably, a monochromatic light source emitting radiation in at least one of the group including UV, visible, and near infrared radiation and, preferably, in the range of 220-1080 nm. The photons collected from the sample include elastically and inelastically scattered photons, and the spectrometer further including means for rejecting the elastically scattered photons. The pumping source is a microwave source.

### CROSS-REFERENCE TO RELATED APPLICATIONS

This application claims the benefit of both provisional application Ser. No. 62/148,432 entitled Differential Excitation Raman Spectroscopy, filed Apr. 16, 2015, and application Ser. No. 14/473,796 entitled Differential Excitation Spectroscopy, filed Aug. 29, 2014 (which, in turn, claims the benefit of provisional application Ser. No. 61/877,144 entitled Differential Microwave Excitation Infrared Spectroscopy, filed Sep. 12, 2013). Application Ser. No. 14/473,796 was published on Mar. 12, 2015 under Publication No. US-2015-0069258-A1. The disclosure of application Ser. No. 14/473796 is incorporated herein by reference.

### GOVERNMENT CONTRACT REFERENCE

Insofar as the invention claimed in this application is directed to Differential Excitation Raman Spectroscopy it was conceived or first reduced to practice as the result of work on a U.S. Government research project, namely: Contract # W911SR-11-C-0061.

### FIELD OF THE INVENTION

This invention relates to a new spectroscopic technique called Differential Excitation Raman Spectroscopy (DERS), a technique variant under the Differential Excitation Spectroscopy (DES) umbrella, which uses a pump-probe methodology to place a molecule (or mode) which is not or may not be IR active into one or more excited rotational states and measuring the vibrational states utilizing Raman spectroscopy, which is based on energy shifts due to inelastic photon scattering from the molecule. By evaluating the spectral changes due to the one or more discrete frequencies of pump photons, instead of the one dimensional measure of a molecule (a spectral response curve) that is common to many spectroscopic techniques, a multi-dimensional characterization of the molecule's excited state energy level structure results. This multi-dimensional characterization typically involves evaluating the changes between excited state (or perturbed) and unexcited (or base) state measurements. The differential nature of the evaluation makes the technique self-referencing and solves many problems common to many spectroscopic techniques. The multi-dimensionality of the technique provides high specificity and immunity to interferents. The preferred embodiments involve excitation by using photons suited to pumping (i.e., perturbing) the rotational states and evaluating the effects by probing (i.e., interrogating) the energy levels of one or more vibrational states. The technique is capable of detecting both bulk and trace concentrations of a molecule in the gas, liquid and solid phases, both in pure form and in the presence of other molecules. DERS may also be referred to as Differential Microwave-Raman Scattering Spectroscopy or DMRSS for the specific case where the pump photons are in the microwave region.

### BACKGROUND

This application discloses a novel extension of Differential Excitation Spectroscopy (DES) to, for instance, detect and analyze chemical threats, including explosives, chemical warfare agents and environmental pollutants from a remote (stand-off) distance. The method and apparatus of the present invention is termed Differential Microwave-Raman Scattering Spectroscopy (DMRSS) or, more broadly, Differential Excitation Raman Spectroscopy (DERS). DMRSS and DERS can be set apart uniquely from Differential Microwave Excitation IR Spectroscopy (DMIRS) in several ways. Whether used alone or as a complementary method, the DERS method may be employed to expand the overall utility of spectroscopic methods based on double-resonance effects when directed at the detection or analysis of gas-phase molecular species, plasmas, and certain liquid and molecular solids under different or similar situational scenarios.

### SUMMARY OF THE INVENTION

The invention relates to a method of detecting the presence of a molecular species in a sample, which species has vibrational transitions that are not/may not be IR responsive, utilizing one or more frequencies of electromagnetic radiation, including frequencies matched to the molecular species' rotational energy levels, for perturbing (pumping) the rotational states of the molecular species (hereinafter the “matched frequencies”). The rotational states of the molecule create a fine structure imposed on the vibrational energy levels. Therefore, perturbations of the rotational states affect the energies of the vibrational states. Because of this linkage “rovibrational” will be used to describe the composite state of rotational and vibrational modes. In the case of species which are both Raman and IR active, the invention relates to Raman analysis as a complementary technique in order to derive additional information about the structure of matter. The method, which utilizes a means for assessing the Raman response of the molecular species in its perturbed and unperturbed states and for assessing the presence of the molecular species in the sample, includes: assessing the rovibrational density of states of the molecular species as manifested by its Raman response in at least one region of the electromagnetic spectrum; assessing the perturbed state of the molecular species by perturbing the rovibrational density of states of the molecular species using frequencies of electromagnetic radiation selected from the matched frequencies and determining with Raman techniques the effects of the perturbation on the spectral response of the rovibrational density of states of the molecular species; and assessing the effect the perturbation had on the molecular species using its perturbed and unperturbed Raman responses. Assessing the rovibrational density of states of the molecular species (as manifested by its Raman response in the at least one region of the electromagnetic spectrum) includes interrogating the molecular species with electromagnetic radiation in the at least one region of the electromagnetic spectrum to determine an unperturbed response of the rovibrational density of states of the molecular species. Assessing the response of the perturbed rovibrational density of states of the molecular species includes illuminating the molecular species with electromagnetic radiation frequencies selected from the matched frequencies and interrogating the molecular species with electromagnetic radiation in the at least one region of the electromagnetic spectrum to determine a perturbed response of the rovibrational density of states of the molecular species. The means includes means for determining the change between the Raman response of an unperturbed and a perturbed rovibrational density of states of the molecular species and further including determining the change between the response of the unperturbed and the perturbed rovibrational density of states of the molecular species. Though stated in a particular order, no representation is made or intended that this order is always necessary.

The method can detect one or more chemical species in a sample by selecting the appropriate perturbation frequencies. The changes in affected rovibrational states are manifest in the altered Raman shifts, analogously to the DES technique for IR active molecules.

### BRIEF DESCRIPTION OF THE DRAWINGS

FIGS. 1A and B are rovibrational transition diagrams for conventional Raman spectroscopy (FIG. 1A) and for the microwave-Raman scattering spectroscopy double resonance method of the present invention (FIG. 1 B). Each diagram represents a sub-ensemble of two vibrational (υ″ and υ′) and four rotational (J″ and J′) states within an arbitrary molecular-electronic state (1Σ), and excitations to non-stationary virtual states (* [symbol] ). The red arrows in (B) correspond to rotationally-dressed lower states excited by a microwave source.

FIG. 2 is an exemplary configuration of spectroscopic apparatuses used in the DERS method to interrogate and analyze a sample from a remote location.

### OVERVIEW OF THE TECHNIQUE

Under the Differential Excitation Spectroscopy (DES) umbrella there are a number of technique variants based on methods of probing the rovibrational states. One such variant is Differential Microwave Excitation IR Spectroscopy (DMIRS) as discussed in detail in the above referenced Publication No. US-2015-0069258-A1. A second is Differential Excitation Raman Scattering Spectroscopy (DERS). The skilled practitioner will recognize that these two specific variants represent separately novel subsets of the possible applications of the DES technique. DMIRS is a very practical application in that it uses RF energy to excite the rotational modes (typically from about 100 MHz through 20 THz, depending upon the state of matter, size, shape and symmetry of the molecule) and IR spectroscopy to probe the vibrational response. DMIRS is, however, only applicable to molecules that are IR-active (i.e. possess at least an instantaneous dipole moment) since IR spectral data is required. For molecules or modes which may not be IR active a common measurement approach is Raman spectroscopy, which is based on inelastic photon scattering from the molecule. Hence, the extension of DES to IR-inactive materials, or where a complementary technique is in order, is to excite the rotational modes as described previously and probe the vibrational modes with the Raman technique.

### Background Physics of DERS

The Raman effect was developed theoretically by Smekal (Smekal, 1923) and later discovered experimentally by C. V. Raman in 1928 (Raman & Krishnan, 1928). Raman spectroscopy has evolved into a tool to probe the quantized rovibrational frequencies of molecules as a means of elucidating the structure and composition of matter. In the realm of molecular vibrations and rotations the information obtained from Raman spectroscopy is complementary to that obtained from infrared spectroscopy. However, the instrumental arrangement and the rules that govern the transition of light quanta from one rovibrational state to another are distinct. On a quantum-molecular level, IR transitions (via absorbance) require that individual molecules or molecular elements with matter undergo a change in their dipole moment, whereas Raman transitions (via scattering) require a change in their polarizability. These distinctions lead to differences in molecular selectivity as a consequence of the spatial symmetry resulting from the equilibrium structure of molecules or matter.

In Raman spectroscopy matter is irradiated with an intense beam of monochromic light, such as that from a laser emitting in the UV, visible, or near infrared region of the spectrum. The radiation that is scattered from such matter is analyzed by a spectrometer. The most intense component of that scattered radiation is due to elastic collisions between the incident photons of the laser and the molecules that constitute the matter. This is known as the Rayleigh component of the scattered light and the energy of these photons is equivalent to that of the incident light source. In the Raman effect to be measured a very small portion of the scattered light undergoes inelastic collisions with molecules so that the vibrational and rotational energy of these molecules is changed by some amount ΔE.

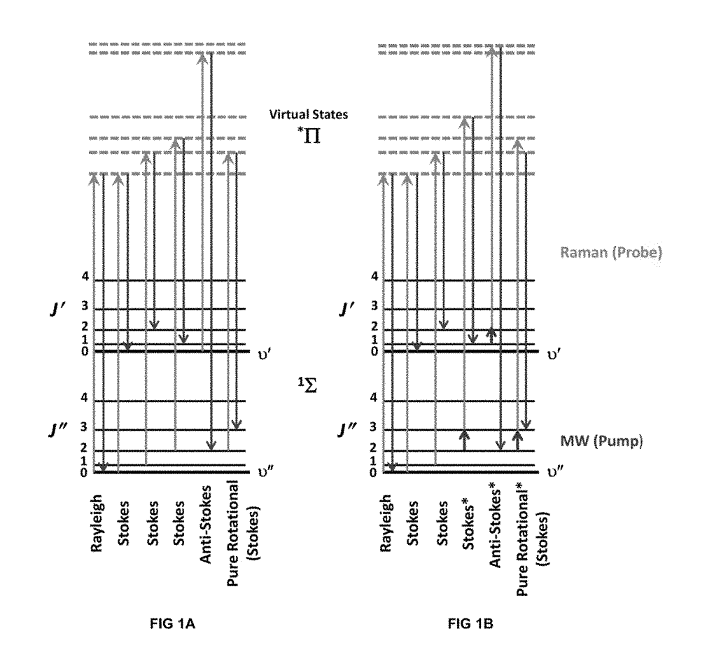

To further illustrate the Raman effect in a quantum mechanical context, FIG. 1A is exemplary of an ensemble of rovibrational state transitions that can be measured using a conventional experimental setup. Molecules in some initial rovibrational state are excited to a short-lived virtual state [¹Σ(υ″, J″)→* [symbol] ] whereupon they immediately lose their energy to exactly one vibrational state away from the initial level, emitting a scattered photon in the process [* [symbol] →¹Σ(υ′,J′) ]. In resonance Raman (not shown) the initial vibrational state may be excited to a real electronic state. The intensity of scattered photons from an electronic chromaphore of the correct symmetry is, however, orders of magnitude greater than the non-resonance case. In addition to rovibrational transitions, a purely rotational Raman spectrum can be observed from transitions in which the scattered photon returns to the same vibrational level, but at a different rotational level than the initial state.

Because the energy of the system must be conserved, the scattered photons emerge with a shift in energy relative to the incident beam. Scattered photons returning with less energy than the incident light are referred to as having undergone a Stokes shift, while those returning with more energy than the incident light have undergone and anti-Stokes shift. The detection and energy dispersion of scattered photons for all Raman processes is done by a spectrometer to produce a Stokes and anti-Stokes spectrum of the matter, which is possible only after removing the Rayleigh scattered photons.

Given a molecule whose geometric structure consists of various atoms with corresponding atomic masses, and where such atoms are connected together by overlapping atomic orbitals to form energetically stable bonds of different orders and distances, submolecular groups of atoms will consistently produce characteristic rovibrational motions in the Raman spectrum that qualitatively identifies them. The object of spectral interpretation is to relate these group vibrational frequencies to molecular structure.

Without physical separation of a mixture of components, the specificity of Raman spectroscopy for distinguishing one molecular component from a different one is encumbered by the overlap of group rovibrational frequencies among molecules of similar structure. Thus, remote sensing technologies that rely on the Raman effect by measuring the rovibrational spectrum of scattered photons from matter of unknown composition have limited utility. In light of this well-known challenge, the objective of the present invention is to substantially enhance the specificity of otherwise conventional Raman measurements by incorporating a second dimension of how matter is interrogated via the selective pre-excitation of rotational states. This is comparable to the double resonance interrogation approach used in the DMIRS method as described in Publication No. US-2015-0069258-A1.

### DESCRIPTION OF THE PREFERRED EMBODIMENT

With this invention, we have developed a novel molecular conditioning technique which allows the density of states of a molecule to be perturbed from a normal ground state distribution through the application of a pump radiation field. The pump radiation field, subject to the normal constraints of transition probability and absorption cross-section, preferentially alters the molecular rotational and vibrational states (again, the rovibrational states) in favor of higher-order modes. This perturbation of the density of states is physically manifested by alterations to the spectrum for the material, with certain portions of the spectrum being strengthened (enhanced) or weakened (suppressed), depending on the applied perturbation. These changes in the spectrum are a sensitive indicator of the underlying molecular species rovibrational states, as a correctly applied perturbation will force the molecule into another state. This distribution of states is highly specific to a molecular species, and similar, but not identical molecular species would not be expected to have the same distribution of states. Hence this technique is a sensitive probe into the detailed density of states for a specific molecular species and is an orthogonal measurement to conventional spectroscopy, as the technique probes more parameters than the ground state distribution. Its implicit reliance on a unique density of states makes it dramatically less susceptible to confusion by similar molecular species (e.g., interferents). It is possible to reach more highly excited states by either using higher energy photons or by applying multiple lower energy photons to reach these states. For a variety of practical reasons, such as atmospheric attenuation, in some DERS applications microwave energy (e.g., 1 GHz-300 GHz) is the preferred form of pump radiation.

A representative radio frequency region of interest is between 100 MHz through 20 THz and encompasses the frequency band containing the fundamental rotational resonance frequencies of many molecules composed of carbon, nitrogen, oxygen and sulfur. For a preferred embodiment the microwave region is utilized. As an inherently differential technique, this novel approach is intrinsically self-referencing, providing a spectroscopic signature that shows high immunity to spectral interference from background and radiation source variations. In a preferred implementation, the DERS response is calculated as the quotient of the “microwave on” and “microwave off” spectra, i.e. the spectra collected with and without the pump (or perturbation) radiation source being active. There are a series of Raman shifts and a range of pump frequencies that provide a multi-dimensional characterization of a molecule's excited state energy structure. The essential value of this higher-dimensionality signature is that the probability of true detection is higher and background interference less important.

The proper combination of spectral regions can be determined empirically by scanning various combinations of excitation electromagnetic radiation (e.g., the microwave radiation) to determine the responses and the unique signature. Alternatively, computational modeling of the molecule to determine its structure and potential energy surface function can be used to determine appropriate combinations of electromagnetic radiation frequencies. In practice, however, the empirical approach does not offer much understanding of the molecule and given the requisite fineness of the pump grid (often about 1 MHz), an empirical study can be very time consuming.

FIG. 1B illustrates the double resonance excitation used in the DERS method. For either Stokes or anti-Stokes scattering one or more of the lower state rotational levels is selectively excited (i.e., dressed) at a MW frequency precisely in resonance with its quantum mechanically allowed rotational transition (i.e., pump), while a second source (i.e., probe) causes a non-resonant transition to a virtual electronic state and subsequent return of inelastically scattered photons to be measured by a spectrometer in accordance with Raman allowed transitions. In the strictest definition such two photon processes are not true double resonance transitions like that described for the DMIRS method (as set forth in Publication No. US-2015-0069258-A1) since the Raman transitions in this particular example involve short lived virtual state. That is, non-stationary states caused by the momentary distortion of electronic distribution. However, true double resonance transitions would occur under the DERS method for electronic chromaphores when the Raman excitation transition is in resonance with one or more real electronic states, otherwise known as resonance Raman.

A significant population of rotationally dressed states can be affected by the resonance conditions for MW excitation as illustrated in FIG. 1B. Accordingly, the net effect on observing (or probing) the Raman spectrum is a change in the shape and intensity of spectral lines corresponding to the Raman transitions being affected by the rotationally dressed states. This condition causes an enhancement or attenuation of rovibrational transition probabilities and state-to-state lifetimes when compared differentially with conventional Raman spectroscopy as illustrated in FIG. 1A. Such enhancements and attenuations are best observed in differential form corresponding to the difference in spectral signal between the MW on state and the MW off state or, alternatively, the quotient of the MW on signal normalized by the MW off signal.

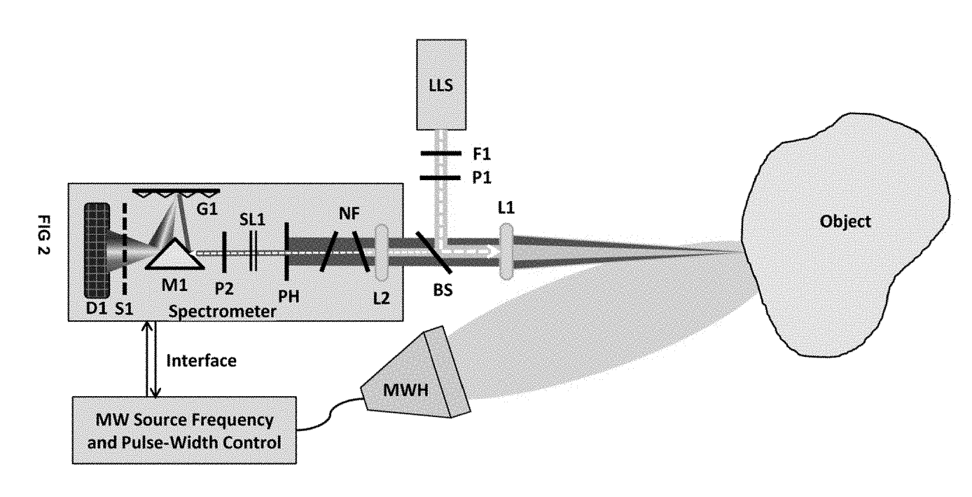

One of several possible configurations of the DERS method consists of four principal sub-units as illustrated in FIG. 2, namely: (1) a monochromatic light source such as laser LLS; (2) a Raman spectrometer; (3) MW generating electronics for frequency and pulse-width control of MW radiation; and (4) a MW transmitter such as MW horn MWH. The measurement scenario discussed above in connection with FIG. 1B is directed at interrogating an object at a point, or a point in space, from a remote location using a focused beam. The object may consist of matter in the form of a gas, plasma, or certain liquids and molecular solids. A similar configuration may also be used to interrogate a volume in space by scanning the focused beam over an object, or points in space, or imaging scattered light via global illumination of the object or a volume in space using a collimated beam. It is to be understood that in the latter case the internal configuration of the Raman spectrometer is different from that illustrated in FIG. 2, but is well known by those familiar with the art of Raman imaging spectroscopy.

The Raman components consist of a monochromatic light source, such as frequency stabilized diode laser LLS, emitting a well collimated light beam for Raman excitation of any wavelength ranging from the ultraviolet to the infrared, preferably in the range of 220-1080 nm. The beam may be filtered by element F1 to remove the amplified stimulated emission (ASE) component of the LLS, which may also be polarized by polarization element P1, or not polarized via a depolarization element (not shown) at the same location. The object to be interrogated is illuminated with greater than 50% of the output intensity of the monochromatic light source by directing the beam to beam splitter BS, preferably a 90/10 beam splitter, whereby 90% of the incident illumination of the monochromatic wavelength of the LLS is directed to the object and only 10% is transmitted through beam splitter BS. The manner in which the object in space is illuminated is governed principally by the lens system L1. For example, L1 may be a simple lens providing a convergent beam of arbitrary focal length, a multi-element lens system providing a collimated beam of arbitrary diameter, a simple lens providing a divergent beam of arbitrary divergence angle, a multi-element lens system such as a microscope or telescope providing a variable focal length. It is further understood that the optical components employed in the entire system must be compatible with the wavelength selected for Raman excitation.

Elastically and in-elastically scattered photons (the light and dark red beam paths, respectively shown in FIG. 2) from the object, point in space, or volume element in space are collected by the Raman spectrometer via collection optics at L1 and L2. The inelastically scattered photons, the Raman component, are transmitted through beam splitter BS with minimal attenuation because their wavelength shift is in the transmissive range of this element. The elastically scattered photons, the Rayleigh component of the light collected from the object, are removed via notch filters NF, thus allowing collection and spectral dispersion of the Raman component of the scattered light.

Spectral dispersion of Raman scattered photons may be provided by one of several configurations known to those familiar with Raman spectroscopic instrumentation. In the present example illustrated in FIG. 2, the Raman scattered photons are further manipulated to achieve optimum spatial and spectral resolution by employing a collection of optical elements in the beam path beyond notch filters NF, ultimately leading to the discrimination of Stokes and anti-Stokes wavelength shifts which are resolved and detected at detector D1, preferably with the use of a two dimensional detector array. For example, confocality of a point on the object, or point in space, may be provided by pinhole PH and slit SL1, while selection of the polarization angle of the Raman scattered light may be provided by second polarizer P2. Dispersive Raman spectrometers such as that illustrated in FIG. 2 may be employed to provide spectral dispersion of the Raman scattered light by employing one or more mirrors M1 to increase the path length and grating G1. However, non-dispersive configurations employing, for example, a Michelson interferometer and fast Fourier transformation (FFT) of the resultant interferograms are also contemplated in the present invention.

The novel aspects of the instrumentation depicted in FIG. 2 include the frequency selective, MW generating components used in tandem with the Raman instrumentation described above. Resonance excitation of rotationally dressed states of matter is achieved by directing MW radiation toward the point in space being interrogated by laser LLs of the Raman system. One or more MW transmission devices, such as MW horns, may be employed depending on the frequency and frequency range required for resonance excitation of select rotational states. The frequency and pulse width of this resonant radiation is controlled by the MW source controller. This controller is interfaced with the Raman spectrometer so that the collection of Raman scattered photons can be coordinated or triggered with the MW excitation via a communication interface and control of shutter S1. In this exemplary arrangement the DERS method may be carried out under a variety of interrogation scenarios. For example, the MW source may be pulsed for a predefined duration during which time the rovibrational Raman response is measured. Alternatively, matter may be irradiated continuously at a resonant MW frequency while the Raman response is collected under time varying conditions. In either case enhanced specificity of the double resonance effect for discriminating the molecular constituents of matter may be afforded by coupling with the state-to-state lifetimes of the rovibrational transitions.

The difference between the spectral response of the unperturbed and the perturbed rovibrational density of states of a molecular species in a sample may be used, by a routine(s) in a control and analysis computer to determine the presence of such molecular species in the sample, such presence affected by its concentration. The methodology uses the response of the molecular species within a sample at a known power of frequencies of electromagnetic radiation selected from the matched excitation frequencies for perturbing the rovibrational density of states of the molecular species in the sample and known conditions for assessing the spectral response of the molecular species in its perturbed and unperturbed states and relating the molecular species' response to a pre-compiled library of calibrated responses collected under the same conditions from known concentrations of the molecular species. The library, not shown, is stored in the control and analysis computer. The method includes: assessing the rovibrational density of states of the molecular species as manifested by its spectral response in at least one region of the electromagnetic spectrum under known assessment conditions; assessing the perturbed state of the molecular species by perturbing the rovibrational density of states of the molecular species using known powers of frequencies of electromagnetic radiation selected from the matched frequencies and determining the effects of the known perturbation on the spectral response of the rovibrational density of states of the molecular species; and assessing the effect the perturbation had on the molecular species using its perturbed and unperturbed spectral responses as related to the pre-compiled library.

While the foregoing is in reference to a sample of a single molecular species, the apparatus and the methodology of the present invention can be used to detect the presence of one or more additional molecular species included in a sample.

Whereas the drawings and accompanying description have shown and described the preferred embodiments of the present invention, it should be apparent to those skilled in the art that various changes may be made in the forms and uses of the invention without affecting the scope thereof.

We claim:

1. Raman instrumentation for detecting for the presence of a molecular species in a sample based on the selective excitation of rotationally dressed states of such species, while probing the affected rovibrational transitions of scattered photons, the instrumentation including:
a source of radiation for pumping the sample;
apparatus for controlling at least one of the frequency and pulse width of radiation from the pumping source;
a Raman spectrometer including a detector and means for collecting scattered photons from the sample;
a radiation source for probing the sample;
means for directing radiation from the probing source to the sample; and
means to interface the Raman spectrometer with the source of radiation for pumping, whereby the collection of scattered photons from the sample is coordinated with the pumping.

2. The instrumentation of claim 1, wherein the radiation source for probing is a monochromatic light source emitting radiation in at least one of the group including UV, visible, and near infrared radiation.

3. The instrumentation of claim 2, wherein the radiation is in the range of 220-1080 nm.

4. The instrumentation of claim 2, further including means for polarizing the radiation from the monochromic light source.

5. The instrumentation of claim 1, wherein photons collected from the sample include both elastically scattered photons and inelastically scattered photons, and wherein the Raman spectrometer further including means for rejecting the elastically scattered photons.

6. The instrumentation of claim 5, wherein the means for rejecting the elastically scattered photons includes notch filters, thus allowing for the collection and spectral dispersion of the inelastically scattered photons.

7. The instrumentation of claim 6, wherein the Raman spectrometer includes means for resolving the frequency of the inelastically scattered photons.

8. The instrumentation of claim 7, wherein the means for resolving the frequency of the inelastically scattered photons is selected from the group including dispersive devices and non-dispersive devices.

9. The instrumentation of claim 1, wherein the frequency of the pumping source is selected from the range 100 MHz through 20 THz.

10. The instrumentation of claim 9, wherein the pumping source is a microwave source.

11. The instrumentation of claim 10, wherein the apparatus for controlling the microwave source is capable of locking in MW frequencies within 10 kHz or less of the frequency required for dressing specific rotational states of the molecular species.

12. The instrumentation of claim 10, wherein the apparatus for controlling the microwave source includes means for controlling the pulse width of microwaves from the microwave source in order to couple the lifetimes of the excited molecular species with the acquisition of the altered Raman effect.

13. The instrumentation of claim 12, wherein the means for controlling the pulse widths includes means for pulsing the microwave source with pulses widths 1 second.

14. The instrumentation of claim 13, wherein the Raman spectrometer includes means to capture and spectrally resolve inelastically scattered photons within a pulse width duration of 1 second.

15. The method of detecting the presence of at least one molecular species in a sample with the Raman instrumentation of claim 1; the method including:
assessing the rovibrational density of states of the molecular species as manifested by its Raman response in at least one region of the electromagnetic spectrum;
assessing the perturbed state of the molecular species by perturbing the rovibrational density of states of the molecular species using frequencies of electromagnetic radiation selected from the matched frequencies; and
determining the effects of the perturbation on the spectral response of the rovibrational density of states on the molecular species.
